(19) United States
(12) Patent Application Publication
(10) Pub. No.: US 2007/0149185 A1
(43) Pub. Date: Jun. 28, 2007

(54) Method and system of processing an incoming call failure

(75) Inventors: Eun Jung Song, Daejeon (KR); Kwi Nam Moon, Seoul (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: PANTECH CO., LTD.

(21) Appl. No.: 11/493,068

(22) Filed: Jul. 26, 2006

(30) Foreign Application Priority Data
Dec. 22, 2005 (KR) 10-2005-0128095

(51) Int. Cl. H04Q 7/20

(52) U.S. Cl. 455/423

(57) ABSTRACT

A method of processing an incoming call failure includes receiving a notification of an incoming voice call from a mobile switching center (MSC) during a data service; transmitting the notification of the incoming voice call to a mobile station (MS) and receiving an acceptance notification of the incoming voice call from the MS; transmitting an affirmative receipt of the notification of the incoming voice call with respect to the received acceptance notification of the incoming voice call to the MSC; setting a packet paging inactive field; disregarding a packet paging when the packet paging is received from a packet control function in a dormant state; and receiving a call paging from the MSC and transmitting the call paging to the MS.

### CROSS-REFERENCE TO RELATED APPLICATION

This application claims the benefit of Korean Patent Application No. 10-2005-0128095, filed on Dec. 22, 2005, in the Korean Intellectual Property Office, the disclosure of which is incorporated herein by reference.

### BACKGROUND OF THE INVENTION

1. Field of the Invention

The present invention relates to a method and system of processing an incoming call failure which can process a call paging while not releasing a Point-to-Point Protocol (PPP) connection, when a notification of an incoming voice call is received from a mobile switching center (MSC) during a data service, by disregarding a packet paging until a voice call is completely processed, and then processing the packet paging after the voice call is completely processed, and thereby, reconnecting the data service.

2. Description of Related Art

FIGS. 1 and 2 are sequence diagrams illustrating a method of processing of an incoming call according to a conventional art.

As illustrated in FIG. 1, a base station controller (BSC) may receive a notification of an incoming voice call from a mobile switching center (MSC) during a data service, and transmit the notification of the incoming voice call to a mobile station (MS) in the conventional art. Also, the BSC may transmit a base station (BS) acknowledgement order to the MS, transmit an affirmative receipt of the notification of the incoming voice call to the MSC and thus, release a Point-to-Point protocol (PPP) connection.

Also, when a release order is received from the MS and a call paging is received from the MSC, the call paging may be transmitted to the MS. Accordingly, when the MS is ready to receive a paging message and a voice call is completed, the previously released data service is reconnected.

However, in the conventional art, when the BS acknowledgement order is received in the MS, the PPP connection is released without entering a dormant state. When in the dormant state after transmitting the release order, the data service is reconnected because the packet paging is received before the call paging. Accordingly, a problem failing to connect the voice call is caused. In the case of entering the dormant state after transmitting the release order, a packet paging prior to the call paging is transmitted and thus, a connection of the voice call fails.

Also, in a method of releasing a PPP connection whenever an incoming voice call is received and reestablishing the PPP connection after completing the voice call, a large amount of network resources are required and it takes a significant amount time to reconnect the PPP.

As illustrated in FIG. 2, when a notification of the incoming voice call is received in the dormant state, the data service is connected by the data paging. Accordingly, a voice connection may fail. Namely, since the packet paging for the data service is received earlier, thereby disregarding the call paging, incoming voice call may fail.

A new method which can reduce network resource requirements and reduce required time for reconnecting a data service by processing a call paging without releasing a PPP connection, when an incoming voice call paging is received during the data service, and processing the packet paging when the incoming voice call is completed is required.

### BRIEF SUMMARY

An aspect of the present invention provides an incoming call processing method and system which can manage a packet paging in a base station controller (BSC) while maintaining a Point-to-Point protocol (PPP) service when an incoming call notification is received during a data service.

An aspect of the present invention also provides an incoming call processing method and system which can reduce a time required for reconnecting a data service by processing a call paging of a portable device without releasing a PPP connection, when an incoming voice call is received during the data service, processing the packet paging when the incoming voice call is completed and thus, reconnecting the data service.

An aspect of the present invention also provides an incoming call processing method and system which enables a voice call connection even in a dormant state by disregarding a packet paging which is received from a packet control function (PCF), and processing a call paging first, while processing the voice call.

An aspect of the present invention also provides an incoming call method and system which can efficiently manage network resources by maintaining a PPP connection even while processing the voice call and providing a data service with respect to the PPP connection when processing of the voice call is completed.

According to an aspect of the present invention, there is provided a method of processing an incoming call failure, the method including: receiving a notification of an incoming voice call from a mobile switching center (MSC) during a data service; transmitting the notification of the incoming voice call to a mobile station (MS) and receiving an acceptance notification of the incoming voice call from the MS; transmitting an affirmative receipt of the notification of the incoming voice call with respect to the received acceptance notification of the incoming voice call to the MSC; setting a packet paging inactive field; disregarding a packet paging when the packet paging is received from a packet control function (PCF) in a dormant state; and receiving a call paging from the MSC and transmitting the call paging to the MS.

According to another aspect of the present invention, there is provided a system of processing an incoming call failure, the system including: an MSC communication unit receiving a notification of the incoming voice call from an MSC during a data service; a mobile station communication unit transmitting the notification of the incoming voice call to an MS and receiving a acceptance notification of the incoming voice call from the MS; and a packet paging processing unit disregarding a packet paging when the packet paging is received from a PCF in a dormant state, wherein the MSC communication unit transmits an affirmative receipt of the notification of the incoming voice call with respect to the received acceptance notification of the incoming voice call to the MSC and receives a call paging from the MSC, and the mobile station communication unit transmits the call paging to the MS.

### BRIEF DESCRIPTION OF THE DRAWINGS

The above and/or other aspects and advantages of the present invention will become apparent and more readily appreciated from the following detailed description, taken in conjunction with the accompanying drawings of which:

FIGS. 1 and 2 are sequence diagrams illustrating a method of processing of an incoming call according to a conventional art.

FIG. 3 is a sequence diagram illustrating a method of processing an incoming call failure according to an embodiment of the present invention.

FIG. 4 is a block diagram illustrating a configuration of a system of processing an incoming call failure according to an embodiment of the present invention.

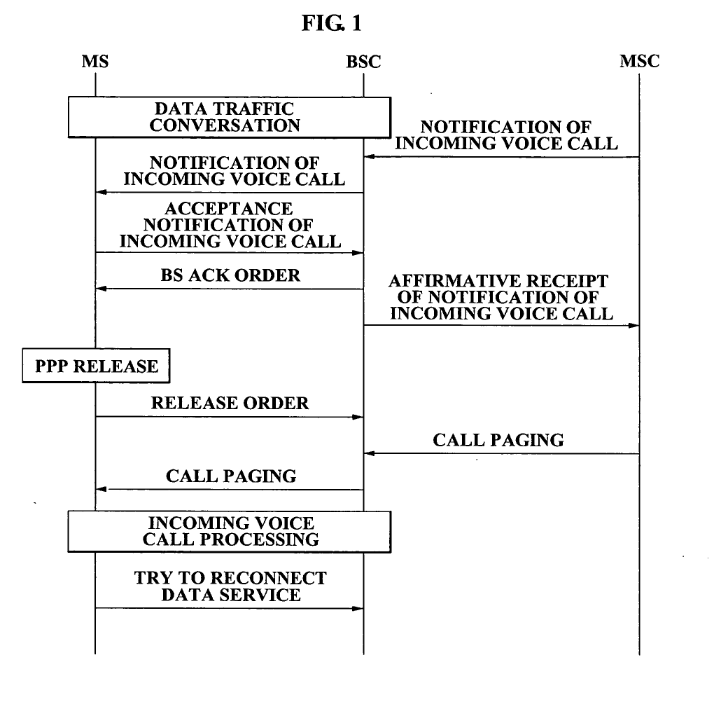

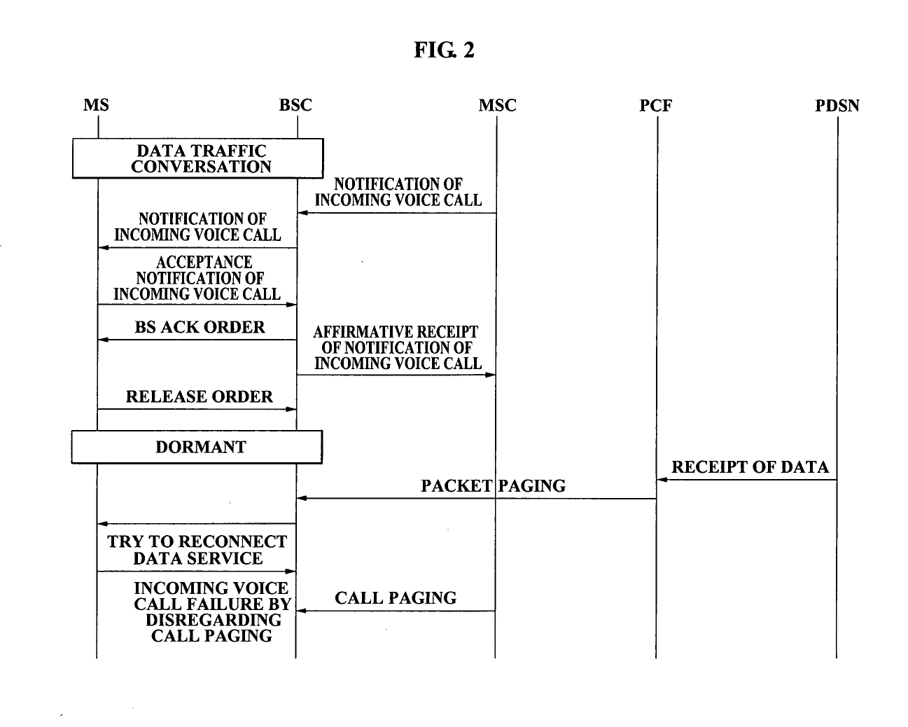

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

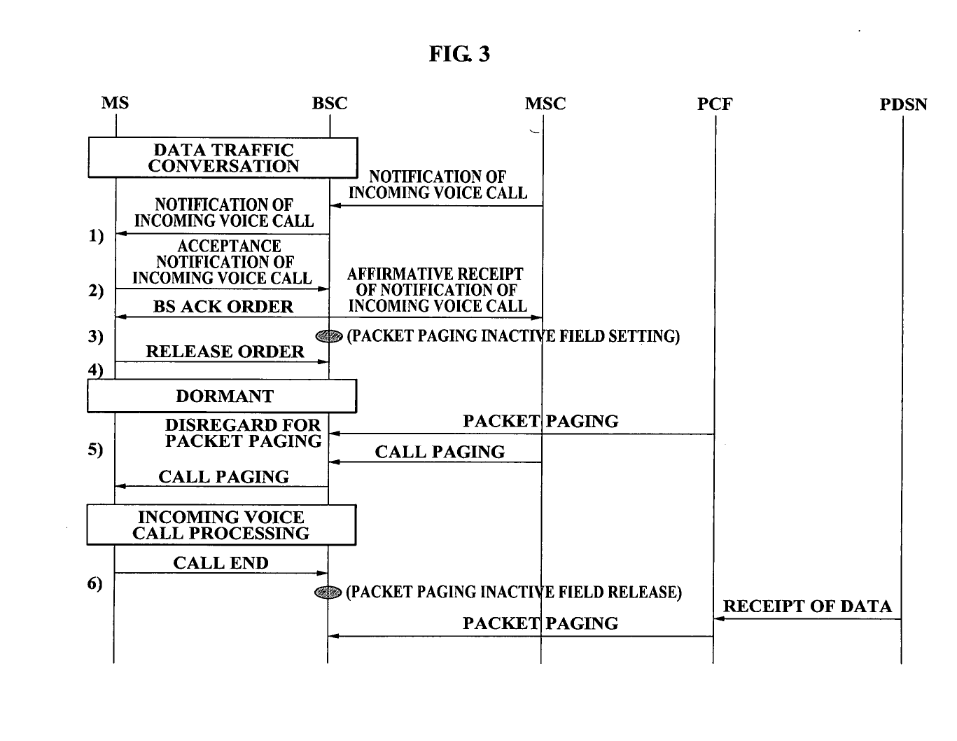

FIG. 3 is a flowchart illustrating a method of processing an incoming call failure according to an embodiment of the present invention.

The method of processing the incoming call failure according to an embodiment of the present invention may be performed in a base station controller (BSC). In this instance, the BSC may provide a data service in interoperation with a mobile station (MS). The data service may transmit/receive a content between portable devices or between a server and a portable device.

In operation 1, the BSC may receive a notification of an incoming voice call from a mobile switching center (MSC). The notification of an incoming voice call may indicate that a sending terminal requests a receiving terminal for a call connection.

In operation 2, the BSC may transmit a notification of the incoming voice call to the MS and receive an acceptance notification of the incoming voice call with respect to the notification of the incoming voice call from the MS. The acceptance notification of the incoming voice call may be that the receiver terminal accepts a call connection request of the sender terminal.

In operation 3, the BSC may transmit an affirmative receipt of the notification of the incoming voice call to the MSC. Also, the BSC may transmit a base station acknowledgement order with respect to the acceptance notification of the incoming voice call to the MS. The BSC may set a packet paging inactive field. Although a packet paging is received for the data service, when a voice call is received, the packet paging inactive field may be used for determining whether to disregard the packet paging. According to an embodiment of the present invention, the BSC may enter a dormant state without releasing a Point-to-Point protocol (PPP) connection when the packet paging inactive field is set.

In operation 4, the BSC may receive a release order from the MS with respect to the base station acknowledgement order transmitted to the MS. Accordingly, the BSC may enter the dormant state. The dormant state may be a standby state for receiving an order. Also, the dormant state may be a state before the receiver terminal receives the incoming voice call from the sender terminal. The BSC may disregard the packet paging when the packet paging is received from a packet control function (PCF) in the dormant state.

In operation 5, the BSC may receive a call paging from the MSC and transmit the call paging to the MS. Accordingly, the BSC may process an incoming voice call. The incoming voice call processing may be entering a state that the receiver terminal and the sender terminal are connected.

In operation 6, the BSC may reset the packet paging inactive field after performing an incoming voice call processing. The BSC may reconnect the data service by processing the received packet paging when the incoming voice call between the receiver terminal and the sender terminal is completed.

According to an embodiment of the present invention, when an incoming voice call is received during the data service, the BSC processes the call paging of the portable device without releasing the PPP connection. Also, the BSC reconnects the data service by processing the packet paging after processing of the voice call is completed. Accordingly, the BSC may reduce time for reconnecting the data service.

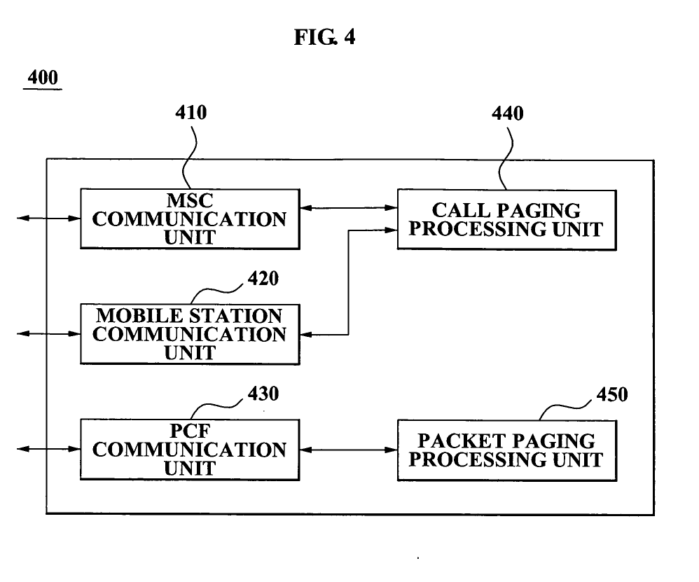

FIG. 4 is a block diagram illustrating a configuration of a system of processing the incoming call failure according to an embodiment of the present invention.

An incoming call processing system 400 may include an MSC communication unit 410, a mobile station communication unit 420, a PCF communication unit 430, a call paging processing unit 440, and a packet paging processing unit 450. According to an embodiment of the present invention, the incoming call processing system 400 may be performed in a BSC.

The MSC communication unit 410 may receive a notification of the incoming voice call from the MSC during data service. The notification of the incoming voice call may be that a sender terminal or a predetermined server requests the receiver terminal for a call connection.

The mobile station communication unit 420 may transmit the notification of the incoming voice call to the MS and receive an acceptance notification of the incoming voice call, with respect to the notification of the incoming voice call, from the MS. The mobile station communication unit 420 may transmit a base station acknowledgement order.

The MSC communication unit 410 may transmit an affirmative receipt of the notification of the incoming voice call with respect to the received acceptance notification of the incoming voice call to the MSC.

When the mobile station communication unit 420 receives the release order from the MS, the call paging processing unit 440 may enter a dormant state. The dormant state may be a standby state for receiving an order.

The packet paging processing unit 450 may disregard a packet paging when a packet paging inactive field is set and the packet paging is received, by the PCF communication unit 430 in the dormant state, from the PCF. The packet paging may be for the data service and disregarded while receiving the incoming voice call.

The MSC communication unit 410 may receive a call paging from the MSC and the mobile station communication unit 420 may transmit the call paging to the MS. Accordingly, the call paging processing unit 440 may enter the dormant state without releasing a PPP connection when the packet paging inactive field is set.

The packet paging processing unit 450 may reset the packet paging inactive field after processing the voice call, and process the packet paging that is received from the PCF. Accordingly, the packet paging processing unit 450 may reconnect the data service by processing the packet paging.

A portable device as used throughout the present specification includes mobile communication devices, such as a computer terminal, a communication terminal, a public switched telephone network (PSTN) terminal, a voice over Internet Protocol (VoIP), a session initiation protocol (SIP), a media gateway control (Megaco), a personal digital assistant (PDA), a mobile phone, a personal communication service (PCS) phone, a hand-held PC, a Code Division Multiple Access (CDMA)-2000 (1×, 3×) phone, a Wideband CDMA phone, a dual band/dual mode phone, a Global System for Mobile Communication (GSM) phone, a mobile broadband system (MBS) phone, or a satellite/terrestrial Digital Multimedia Broadcasting (DMB) phone, and the like.

The method of processing an incoming call failure according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an aspect of the present invention, it is possible to reduce a time for reconnecting a data service by processing a call paging of the portable device without releasing a PPP connection, when an incoming voice call is received during the data service, processing the packet paging when the incoming voice call is completed and thus, reconnecting the data service.

Also, according to an aspect of the present invention, it is possible to enable a voice call connection even in a dormant state by disregarding the packet paging which is received from a PCF, and processing a call paging first while processing the voice call.

Also, according to an aspect of the present invention, it is possible to efficiently manage network resources by maintaining a PPP connection even while processing the voice call and providing a data service with respect to the PPP connection when processing of the voice call is completed.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of processing an incoming call failure, the method comprising:
receiving a notification of an incoming voice call from a mobile switching center (MSC) during a data service;
transmitting the notification of the incoming voice call to a mobile station (MS) and receiving an acceptance notification of the incoming voice call from the MS;
transmitting an affirmative receipt of the notification of the incoming voice call with respect to the received acceptance notification of the incoming voice call to the MSC;
setting a packet paging inactive field;
disregarding a packet paging when the packet paging is received from a packet control function (PCF) in a dormant state; and
receiving a call paging from the MSC and receiving the incoming voice call by transmitting the call paging to the MS.

2. The method of claim 1, further comprising:
entering the dormant state without releasing a Point-to-Point Protocol (PPP) connection when the packet paging inactive field is set.

3. The method of claim 2, further comprising:
transmitting a base station acknowledgement order, with respect to the acceptance notification of the incoming voice call, to the MS; and
entering the dormant state by receiving a release order from the MS.

4. The method of claim 1, further comprising:
resetting the packet paging inactive field after receiving the incoming voice call; and
processing the packet paging which is received from the PCF.

5. The method of claim 4, further comprising:
reconnecting the data service by processing the packet paging.

6. A computer-readable recording medium storing a program for implementing a method of processing an incoming call failure, the method comprising:
receiving a notification of an incoming voice call from an MSC during a data service;
transmitting the notification of the incoming voice call to an MS and receiving an acceptance notification of the incoming voice call from the MS;
transmitting an affirmative receipt of the notification of the incoming voice call with respect to the received acceptance notification of the incoming voice call to the MSC;
setting a packet paging inactive field;
disregarding a packet paging when the packet paging is received from a PCF in a dormant state; and
receiving a call paging from the MSC and receiving the incoming voice call by transmitting the call paging to the MS.

7. A system of processing an incoming call failure, the system comprising:
an MSC communication unit receiving a notification of an incoming voice call from an MSC during a data service;
a mobile station communication unit transmitting the notification of the incoming voice call to an MS and receiving an acceptance notification of the incoming voice call from the MS; and
a packet paging processing unit disregarding a packet paging when the packet paging is received from a PCF in a dormant state,
wherein the MSC communication unit transmits an affirmative receipt of the notification of the incoming voice call with respect to the received acceptance notification of the incoming voice call to the MSC and receives a call paging from the MSC, and
the mobile station communication unit transmits the call paging to the MS.

8. The system of claim 7, further comprising:
a call paging processing unit entering the dormant state without releasing a PPP connection when the packet paging inactive field is set.

9. The system of claim 8, wherein:
the mobile station communication unit transmits a base station acknowledgement order with respect to the acceptance notification of the incoming voice call to the MS and receives a release order from the MS, and
the call paging processing unit enters the dormant state.

10. The system of claim 7, wherein the packet paging processing unit releases the packet paging inactive field after processing an incoming voice call, and processes the packet paging which is received from the PCF.

11. The system of claim 10, wherein the packet paging processing unit reconnects the data service by processing the packet paging.
